(19) United States
(12) Patent Application Publication
(10) Pub. No.: US 2019/0000122 A1
(43) Pub. Date: Jan. 3, 2019

(54) METHOD FOR MANUFACTURING PROCESSED GINSENG CONTAINING HONEY COMPONENT

(71) Applicant: RAPHADEO CO.,LTD, Chuncheon-si Gangwon-do (KR)

(72) Inventor: Seong Suk HO, Chuncheon-si Gangwon-do (KR)

(21) Appl. No.: 15/742,250

(22) PCT Filed: Nov. 14, 2017
(86) PCT No.: PCT/KR2017/012864

§ 371 Date: Jan. 5, 2018

(30) Foreign Application Priority Data
Nov. 14, 2016 (KR) 10-2016-0151019

(51) Int. Cl. A23L 19/10; A23L 21/25; A23L 5/10; A23L 3/10

(52) U.S. Cl. CPC A23L 19/10; A23L 21/25; A23L 5/10; A23V 2300/24; A23V 2002/00; A23V 2200/14; A23V 2250/2124; A23L 3/10

(57) ABSTRACT

Provided is a method for manufacturing processed ginseng containing a honey component. The method includes preparing a first mixture material containing ginseng and honey; steam-heating the first mixture material; cooling the first mixture material; separating the ginseng and the honey of the first mixture material; cooling the separated ginseng at a low temperature; cooling the separated honey at a room temperature; mixing the ginseng cooled at the low temperature and the honey cooled at the room temperature to form a second mixture material; aging the second mixture material at a low temperature; and acquiring ginseng from the second mixture material. According to the present invention, high-molecular ginsenoside is hydrolyzed by the honey component so that the contents of ginsenosideRg5+Rk1, Rg3, Rh2, and CompoundK, which may be easily absorbed by the body of a human being, increase.

### TECHNICAL FIELD

The present invention relates to a method for manufacturing processed ginseng containing a honey component.

### BACKGROUND ART

Ginseng is a plant pertaining to panax of araliaceae, and the effects of ginseng have been admitted for a long time and ginseng is used for medical stuffs in Korean medicine field.

The roots of the ginseng include saponin, fat-soluble components, polysaccharides, nitride composites, peptide, free sugar, free acids, vitamin, and inorganic components, and among them, many studies on the medical effects of ginsenoside have been made since it was revealed that ginsenoside has an important medical effect. The medical effects of the ginsenoside, which have been known until now, include anti-diabetic activation, an anti-oxidation operation, atherosclerosis, prevention of high blood pressure, activation of functions of a liver, anti-fatigue, anti-stress, and anti-aging.

Large amounts of gensenosideRg1 and Rb1, molecular weights of which are large, are extracted from unprocessed ginseng, and ginsenosideRg5+Rk1, Rg3, Rh2, and CompundK, molecular weights of which are small, are hardly extracted. Accordingly, various method for hydrolyzing high-molecular ginsenoside to low-molecular ginsenoside to increase an absorption rate of the effective components of the ginseng into the body have been required.

Conventionally, in order to take the ginseng, processed red ginseng is boiled to be taken in a liquid state, ginseng is sliced and is preserved in honey, or ginseng slices are taken together with honey.

However, when the processed red ginseng is boiled and taken in a liquid state, various beneficial components of the ginseng cannot be taken, and when the ginseng is submerged in honey so that the ginseng slices are taken together with honey, there is a limit in that more than the effect of taking the effective components of the ginseng and the honey cannot be expected.

Korean Patent Publication No. 10-2013-0120069 (Published on Nov. 4, 2013 and entitled “Ginseng Provided as Functional Food and Method for Manufacturing the Same”) discloses ginseng provided as a functional food, and the patent document fails to disclose ginseng in which nutrient components are preserved.

### DISCLOSURE

### Technical Problem

The present invention has been made in an effort to solve the above-mentioned problems, and provides processed ginseng that contains a large amount of low-molecular ginsenosideRg5+Rk1, Rg3, Rh2, and CompoundK, which may be easily absorbed into the body of a human being, increases sweet taste by absorbing much honey, and allows smooth mouth-feel, and a method for manufacturing the same.

### Technical Solution

In accordance with an aspect of the present invention, there is provided a method for manufacturing processed ginseng containing a honey component, the method including preparing a first mixture material containing ginseng and honey, steam-heating the first mixture material, cooling the first mixture material, separating the ginseng and the honey of the first mixture material, cooling the separated ginseng at a low temperature, cooling the separated honey at a room temperature, mixing the ginseng cooled at the low temperature and the honey cooled at the room temperature to form a second mixture material, aging the second mixture material at a low temperature, and acquiring ginseng from the second mixture material,wherein the cooling of the separated ginseng at the low temperature is performed in a temperature range of 2° C. to 6° C. for 12 to 24 hours such that a coupling force of the honey that penetrated into the separated ginseng and the separated ginseng is improved, and is performed in a state in which the separated ginseng is blocked from the outside such that the moisture in the interior of the ginseng is not extracted from the separated ginseng,wherein the cooling of the separated ginseng at the room temperature is performed at a room temperature in a temperature range that is higher than the temperature of the cooling of the separated ginseng at the low temperature, and wherein the aging of the second mixture material at the low temperature is performed in a temperature range of 2° C. to 6° C. for 12 hours to 24 hours.

The steam-heating of the first mixture material and the cooling of the first mixture material may be performed two times or more.

The method may further include aging the ginseng acquired from the second mixture material at a low temperature.

The aging of the ginseng acquired from the second mixture material at the low temperature may be performed at a temperature of 2° C. to 6° C. for 12 hours to 24 hours.

The weight ratio of the ginseng and the honey contained in the first mixture material may be 1 2 to 1 3.

The steam-heating of the first mixture material may be performed at a temperature of 95° C. to 105° C. for 4 hours to 8 hours.

The cooling of the first mixture material may be performed for 30 minutes to 1 hour.

The steam-heating of the first mixture material may be performed in a germanium containing container.

The ginseng may be acquired and then is vacuum-packaged.

In accordance with another aspect of the present invention, there is provided processed ginseng containing a honey component which is manufactured by the method.

### Advantageous Effects

According to the present invention, high-molecular ginsenoside is hydrolyzed by the honey component by repeating steam-heating, cooling, and aging so that the contents of ginsenosideRg5+Rk1, Rg3, Rh2, and CompoundK, which may be easily absorbed by the body of a human being, increase.

Further, the honey may penetrate into the ginseng deep and glucose and fructose contained in the honey may be suitably absorbed into the body through ingestion of the ginseng, and accordingly the speed of absorption of glucose and fructose into the body may increase to be helpful to recovery of fatigue.

Moreover, the mouth-feel may be softened as the ginseng contains the honey component, and the ginseng may be easily taken, and the nutrients of the ginseng may be rapidly absorbed.

### DESCRIPTION OF THE INVENTION

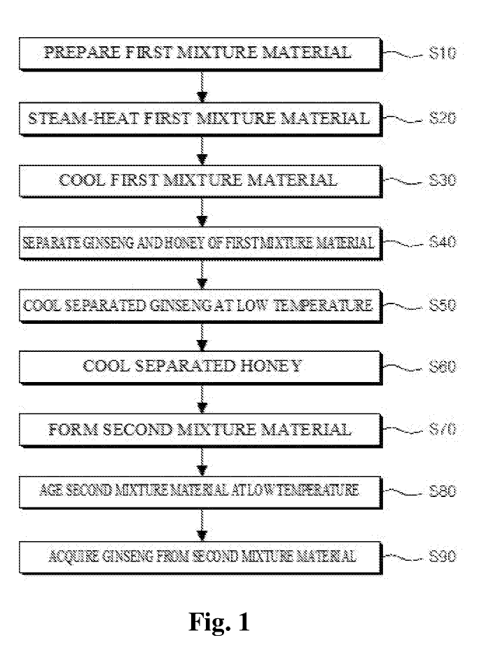

FIG. 1 is a flowchart of a method for manufacturing processed ginseng containing a honey component according to an embodiment of the present invention;

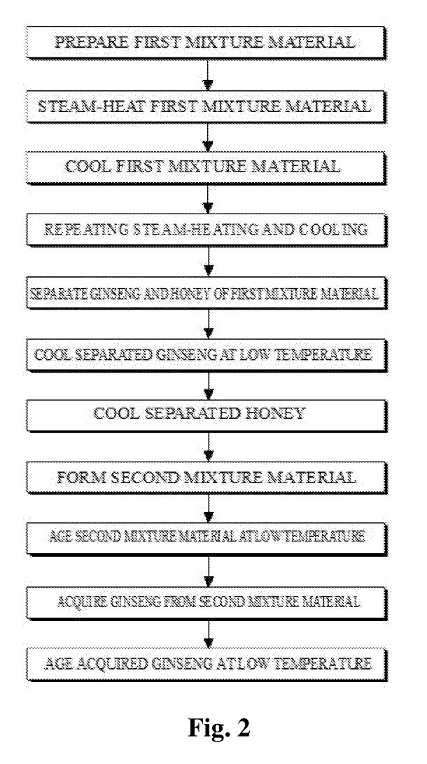

FIG. 2 is a flowchart of a method for manufacturing processed ginseng containing a honey component according to an embodiment of the present invention;

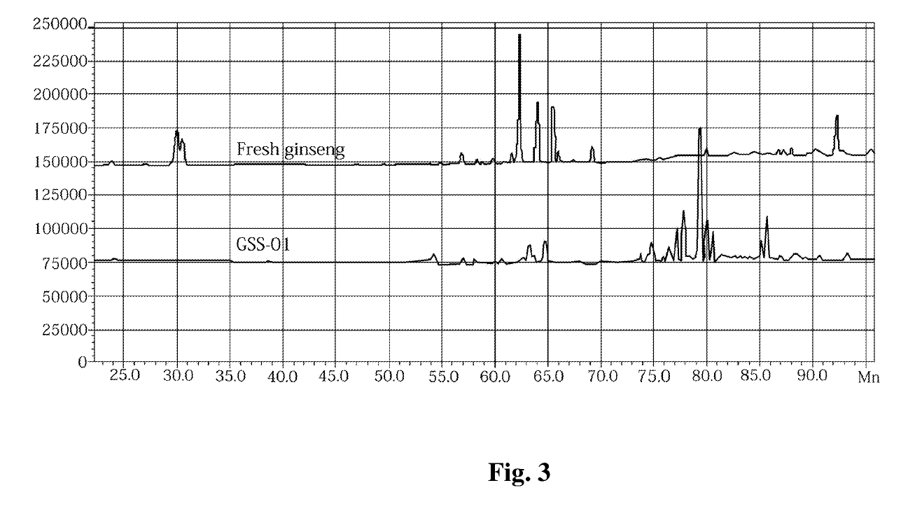

FIG. 3 is a chromatogram graph for comparing processed ginseng containing a honey component manufactured according to an embodiment of the present invention and unprocessed fresh ginseng pertaining to a control group; and

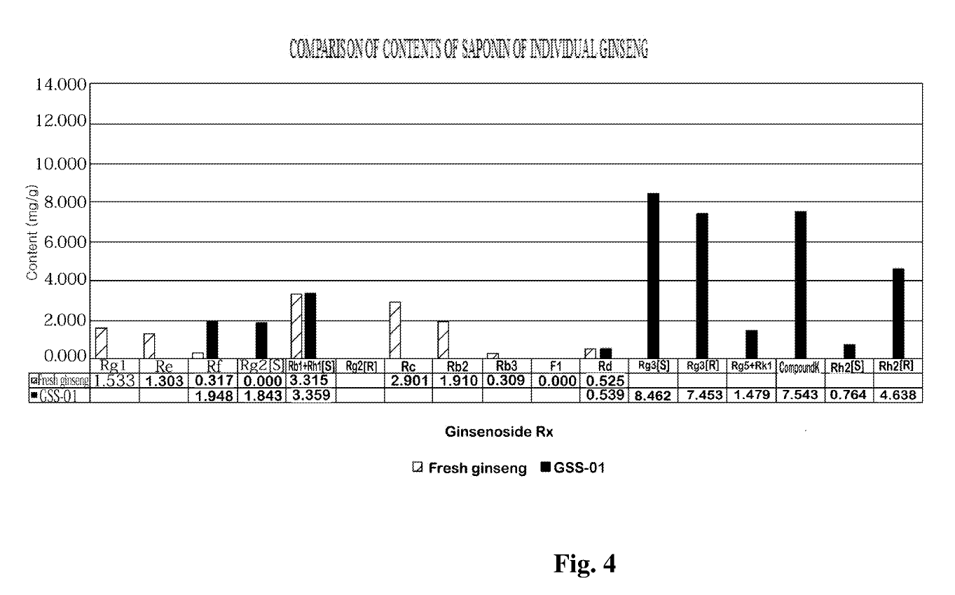

FIG. 4 is a graph for comparing the contents of saponin of processed ginseng containing a honey component manufactured according to an embodiment of the present invention and unprocessed fresh ginseng.

### BEST MODE

Hereinafter, a method for manufacturing processed ginseng containing a honey component according to an embodiment of the present invention will be described. However, the present invention is not limited to the implementations, the embodiments, and the drawings.

A first aspect of the present invention relates to a method for manufacturing processed ginseng containing a honey component, the method including: preparing a first mixture material containing ginseng and honey; steam-heating the first mixture material; cooling the first mixture material; separating the ginseng and the honey of the first mixture material; cooling the separated ginseng at a low temperature; cooling the separated honey at a room temperature; mixing the ginseng cooled at the low temperature and the honey cooled at the room temperature to form a second mixture material; aging the second mixture material at a low temperature; and acquiring ginseng from the second mixture material.

FIGS. 1 and 2 are flowcharts of methods for manufacturing processed ginseng containing a honey component according to an embodiment of the present invention.

First, a first mixture material containing ginseng and honey is prepared (S10).

In detail, the first mixture material is prepared by clearly washing ginseng and mixing the clearly washed ginseng with honey.

Then, it is preferable that the used ginseng is 4-year-old ginseng or 6-year-old ginseng.

The ginseng is carefully washed not to damage the original shape of the ginseng, and the ginseng is sufficiently submerged in the honey. It is preferable that the weight ratio of the ginseng and the honey is 1:2 to 1:3.

The ginseng, for example, may be fresh ginseng, fine ginseng, wild ginseng, cultivated ginseng, deodoek, or balloon flower roots.

Subsequently, the first mixture material is steam-heated (S20).

Then, the component of the honey and the component of the ginseng are coupled to each other such that a thermochemical reaction may be actively made.

The steam heating may be performed after the first mixture material is introduced into a steam heater having a cover that may block the interior and the exterior of the steam heater and while the interior and the exterior of the steam heater are blocked by closing the cover.

The first mixture material, for example, may be steam-heated in a germanium containing container, but the present invention is not limited thereto.

When the germanium containing container is used, infrared rays are emitted in the steam-heating process, and then, the ginseng is sufficiently steam-heated by the emitted infrared rays. In the steam-heating process, the effective components contained in the ginseng is hydrolyzed, a surface of the ginseng is expanded by the heat, and more honey may penetrate into the expanded surface of the ginseng.

Accordingly, it is preferable that the steam-heating is performed at a temperature of about 90° C. to about 105° C. for four to eight hours.

Because the ginseng cannot be sufficiently steam-heated if the time for the steam-heating is low or the steam-heating temperature is low and the taste of the ginseng may be modified to a bitter taste and the original shape of the ginseng may be damaged so that the product value of the ginseng deteriorates fi the steam-heating time is excessive or the stream-heating temperature is high, it is preferable that the ginseng is steam-heated in the time and temperature ranges according to the size and amount of the ginseng.

Subsequently, the first mixture material is cooled (S30).

Because the original shape of the ginseng is damaged if the ginseng is immediately separated from the steam-heated first mixture material, the first mixture material stream-heated for a predetermined period of time in the steam-heating step is cooled.

It is preferable that the ginseng is cooled for about 30 minutes to about 1 hour, and it is preferable that the cover is not opened so that the moisture of the ginseng is not extracted when the steam-heating is performed by the stream heater. Generally, it is advantageous to maintain the interior of the steam heater, the cover of which is not opened, is maintained at a temperature of about 80° C. or more.

Only a portion of the ginseng is steam-heated through the step of cooling the first mixture material so that the shape and the color of the ginseng may be prevented from being modified and the ginseng may be uniformly steam-heated.

According to an implementation of the present invention, it is preferable that the step of stream-heating the first mixture material and the step of cooling the first mixture material are repeated two or more times. Because the honey may not sufficiently penetrate into the ginseng when the steam-heating step and the cooling step are performed only once in the case in which the ginseng is large and heavy, it is preferable that the number of repetitions of the steam-heating step and the cooling step becomes larger as the ginseng is larger and heavier.

In the repetitions of the steam-heating step and the cooling step, it is preferable that the first mixture material is mixed such that the temperatures of the upper and lower sides of the first mixture material are uniform.

The honey may penetrate into the ginseng while repeating the steam-heating step and the cooling step, high-molecular ginsenoside and low-molecular ginsenoside of the ginseng may be decomposed to change an available component ratio of the ginseng while the thermochemical reactions of the honey component and the ginseng component are repeated several times.

Subsequently, ginseng and honey are separated from the first mixture material that has undergone the repetition steps.

This is to make the diffusion and the osmosis of the honey component active by using the temperature difference between the interior and the exterior of the ginseng in a low-temperature aging step of the second mixture material, which will be described below, by performing a step of cooling the separated ginseng at a low temperature and a step of cooling the separated honey, which will be described below.

Subsequently, the separated ginseng is cooled at a low temperature (S50).

The viscosity of honey that penetrated into the ginseng becomes higher so that the honey is stuck to the ginseng stronger. Further, through the low-temperature cooling step, the external shape of the ginseng may be maintained. Accordingly, it is preferable that the cooling is performed at a temperature of about 2° C. to about 6° C. for 12 to 24 hours.

When the step of cooling the ginseng is performed while the cover is opened, the moisture in the ginseng is evaporated and a surface of the ginseng is oxidized in the air so that the surface of the ginseng becomes wrinkled and harder. Accordingly, it is preferable that the step of cooling the ginseng is performed while the ginseng is blocked from the exterior such that the moisture and the honey in the ginseng may not be extracted, but the present invention is not limited thereto.

Subsequently, the separated honey is cooled at a room temperature (S60).

In order to actively perform diffusion and osmosis of the honey component by using the temperature difference between the interior and the exterior of the ginseng in the step of aging the second mixture material, which will be described below, it is preferable that the cooling step is performed at a temperature that is higher than the temperature at which the low-temperature cooling of the ginseng is performed and is performed at a room temperature for an aspect of costs.

The cooling step may be performed for about 12 hours to about 24 hours.

Subsequently, the ginseng cooled at the low temperature and the honey cooled at the room temperature are mixed to form a second mixture material (S70).

Subsequently, the second mixture material is aged at a low temperature (S80).

The temperature of the honey cooled at the room temperature is higher than the temperature of the ginseng cooled at the low temperature, and the concentration of the honey is higher than the temperature of the interior of the ginseng due to the moisture of the interior of the ginseng. That ism, the diffusion and the osmosis may be actively performed in the step of aging the second mixture material due to the temperature difference and the concentration difference between the interior and the exterior of the ginseng. As a result, the moisture in the interior of the ginseng of the second mixture material may be extracted to the outside, and the honey of the second mixture material enters the ginseng from the outside of the ginseng.

In the step of aging the second mixture material, it is important to age the second mixture material through movement of the moisture in the interior of the ginseng and the honey on the outside of the ginseng such that the concentrations of the interior and the exterior of the ginseng may be in an equilibrium state.

The second mixture material may be aged at a low temperature of about 2° C. to about ° C. for about 12 hours to about 24 hours.

Subsequently, ginseng is acquired from the second mixture material (S90).

Subsequently, the acquired ginseng is aged at a low temperature.

Because the viscosity of the honey that penetrated into the ginseng is sensitive to temperature, the shape of the acquired ginseng may be maintained as the honey in the interior of the acquired ginseng is not extracted but is stabilized in the interior of the ginseng while the step of aging the acquired ginseng at a low temperature is performed. Accordingly, it is preferable that the aging is performed at a temperature of about 2° C. to about 6° C. for 12 to 24 hours.

Therefore, processed ginseng having a effective component having a high body absorption rate may be obtained after being processed together with the honey.

According to an implementation of the present invention, the ginseng may be acquired and vacuum-packaged, but the present invention is not limited thereto. The processed ginseng containing the honey component may be preserved for a long period of time through the vacuum-packaging.

Hereinafter, the present invention will be described in detail with reference tio the embodiments of the present invention, but the following embodiments are provided simply for the purpose of description, and the scope of the present invention is not limited thereto.

### MODES FOR CARRYING OUT THE INVENTION

### Embodiment

Manufacturing of Processed Ginseng Containing Honey Component

Washed ginseng and honey are contained in a container at a weight ratio of 1:2 to prepare a first mixture material. After the first mixture material was seated in the interior of a steam heater and a cover of the steam heater are closed such that the interior and the exterior of the cover were blocked from each other, the first mixture material was steam-heated at a temperature of 100° C. for six hours. The steam-heated first mixture material was cooled for 45 minutes after the cover of the steam heater is closed. Subsequently, the steam-heating of the first mixture material and the cooling of the stream-heated first mixture material were sequentially repeated three times, respectively. Subsequently, the ginseng and the honey were separated from the first mixture material. The separated ginseng was aged at a temperature of 4° C. for 18 hours, and the separated honey was cooled at a room temperature for about 18 hours. Subsequently, the ginseng cooled at the low temperature and the honey cooled at the room temperature were mixed to form a second mixture material, and the second mixture material was aged at a temperature of 4° C. for 18 hours. Subsequently, ginseng was acquired from the second mixture material, and the acquired ginseng was aged at a temperature of 4° C. for 18 hours. The ginseng aged at the low temperature was vacuum-packaged to manufacture processed ginseng containing a honey component. The picture of the processed ginseng containing the honey component manufactured according to the embodiment was shown in FIG. 3 of Korean Patent Application No. 10-2016-0151019 (filed on Nov. 14, 2016) that is a priority application of the present invention.

### EXPERIMENTAL EXAMPLE

Processed Ginseng Analysis Result

According to the test method of Korean food standards code and health functional food code, the processed ginseng manufactured in the embodiment was extracted and was filtered by 0.45 μm PTFE after being purified by using a Sep-pak cartridge to be used in an HPLC analysis.

As a control group, unprocessed 5-year-old fresh ginseng was prepared.

The HPLC apparatus used for the analysis was a Shimadzu 10AvpHPLC system (Shimadzu, Japan), and the column was a GraceApolloRP18 column (250*4.6 mm, 5u) (Grace, U.S.A.). The mobile phase was acetonitrile (HPLC level, J T Baker, U.S.A.) and distilled water for HPLC, and the ratio of the acetonitrile was sequentially increased from 20% (0 min) to 20% (10 min), 26% (42 min), 40% (67 min), 47% (70 min), 65% (80 min), and 65% (93 min), and finally was adjusted to 20% again. The deployment temperature was 40° C., the flow rate was 1.2 ml/min, the chromatogram was detected at 203 nm by using SPD-10Avp (Shimadzu, Japan). The specimen was made by mixing 19 kinds (or more) of geinsenoside of a purity of 99% or more of Chromadex (U.S.A.), and qualitative and quantitative analyses ware made by comparing the analysis sample and the chromatogram. In FIG. 3, the one indicated by GSS-01 is processed ginseng manufactured according to the embodiment of the present invention, 5-year-old fresh ginseng that is a control group is indicated by fresh ginseng.

GinsenosideRf is known to be effective to a neuron pain-killing operation, restraining of oxidation of fat, restraining of aging and mutation, ginsenosideRg2 is known to be effective to restraining of coalition of platelets and improvement of decrease of memory, and a larger amount of ginsenosidesRf and Rg2[S] were detected from the processed ginseng containing a honey component manufactured according to the embodiment as compared with the unprocessed 5-year-old fresh ginseng (see Table 1 and FIG. 4).

GinsenosideRd3 is known to be effective to anti-Alzheimer, blood drop, restraining of transition of cancer cells, and restraining of anti-cancer tolerance, Rh1 is known to be effective to protection of a liver, an anti-tumor operation, restraining of coalition of platelets, and restraining of transition of cancer cells, Rh2 is known to be effective to restraining of proliferation of cancer cells, restraining of proliferation of tumors, and reinforcement of skin immunity, and Rg5+Rk1 has a small molecular weight and is easily absorbed by the body of a human being, and is more effective to anti-Alzheimer, blood drop, restraining of transition of cancer cells, and restraining of tolerance of an antitumor agent than Rg3 and is also effective to increase of the immunity. Finally, CompoundK is known as a final product absorbed by the intestine, and is known to be effective to anti-inflammation, protection of a liver and an intestine, protection of skin, prevention of a neurodegenerative disease, restraining of proliferation of a tumor, an anti-oxidation operation, a fibroma treating operation, and an anti-allergy. It may be identified that large amounts of ginsenosideRg3[S], Rg3[R], Rg5+Rk1, CompoundK, Rh2[S], and RH2[R], which have not be detected from the unprocessed five-year-old fresh ginseng that is a control group, are detected from the processed ginseng containing a honey component manufactured according to the embodiment.

TABLE 1
Unit: mg/g

| Ginsenoside Rx | Fresh ginseng | GSS-01 |
|---|---|---|
| Rg1 | 1.553 | N.D. |
| Re | 1.303 | N.D. |
| Rf | 0.317 | 1.948 |
| Rg2[S] | N.D. | 1.843 |
| Rb1 + Rh1[S] | 3.315 | 3.359 |
| Rg2[R] | N.D. | N.D. |
| Rc | 2.901 | N.D. |
| Rb2 | 1.910 | N.D. |
| Rb3 | 0.309 | N.D. |
| F1 | N.D. | N.D. |
| Rd | 0.525 | 0.539 |
| Rg3[S] | N.D. | 8.462 |
| Rg3[R] | N.D. | 7.453 |
| Rg5 + Rk1 | N.D. | 1.479 |
| CompoundK | N.D. | 7.543 |
| Rh2[S] | N.D. | 0.764 |
| Rh2[R] | N.D. | 4.638 |

N.D.: Not detected

Further, referring to Table 1 together with FIG. 4, it appears that the total amount of ginsenoside of the processed ginseng manufactured according to the embodiment of the present invention is 38.028 and the ginsenoside contains three times or more as large as 12.133 that is the total amount of the gesenoside of the five-year-old fresh ginseng. The result reflects that the amount of ginsenoside that may be absorbed by the body of a human being through the processed ginseng manufactured according to the embodiment of the present invention abruptly increases as compared with that of the unprocessed five-year-old fresh ginseng.

It is known that the molecular weights of ginsenosideRg3[S], RG3[R], Rg5+Rk1, CompoundK, Rh2[S], and Rh2[R] are smaller than the molecular weights of ginsenosideRg1, Re, Rc, Rb2, and F1 such that they may be easily absorbed by the body of a human being, and it may be identified that the contents of low-molecular ginsenosideRg3[S], Rg3[R], Rg5+Rk1, CompoundK, Rh2[S], and Rh2[R], which have not been detected from the unprocessed 5-year-old fresh ginseng that is a control group are higher in the processed ginseng containing a honey component manufactured according to the embodiment.

The scope of the present invention is determined by the claims rather than the description of the invention, and all changes or modifications derived from the meanings and scopes of the claims and the equivalents thereof are construed to be included in the scope of the present invention.

1. A method for manufacturing processed ginseng containing a honey component, the method comprising:
preparing a first mixture material containing ginseng and honey; steam-heating the first mixture material; cooling the first mixture material; separating the ginseng and the honey of the first mixture material; cooling the separated ginseng at a low temperature; cooling the separated honey at a room temperature; mixing the ginseng cooled at the low temperature and the honey cooled at the room temperature to form a second mixture material; aging the second mixture material at a low temperature; and acquiring ginseng from the second mixture material,
wherein the cooling of the separated ginseng at the low temperature is performed in a temperature range of 2° C. to 6° C. for 12 to 24 hours such that a coupling force of the honey that penetrated into the separated ginseng and the separated ginseng is improved, and is performed in a state in which the separated ginseng is blocked from the outside such that the moisture in the interior of the ginseng is not extracted from the separated ginseng,
wherein the cooling of the separated ginseng at the room temperature is performed at a room temperature in a temperature range that is higher than the temperature of the cooling of the separated ginseng at the low temperature, and
wherein the aging of the second mixture material at the low temperature is performed in a temperature range of 2° C. to 6° C. for 12 hours to 24 hours.

2. The method of claim 1, wherein the steam-heating of the first mixture material and the cooling of the first mixture material are performed two times or more.

3. The method of claim 1, further comprising:
aging the ginseng acquired from the second mixture material at a low temperature.

4. The method of claim 3, wherein the aging of the ginseng acquired from the second mixture material at the low temperature is performed at a temperature of 2° C. to 6° C. for 12 hours to 24 hours.

5. The method of claim 1, wherein the weight ratio of the ginseng and the honey contained in the first mixture material is 1:2 to 1:3.

6. The method of claim 1, wherein the steam-heating of the first mixture material is performed at a temperature of 95° C. to 105° C. for 4 hours to 8 hours.

7. The method of claim 1, wherein the cooling of the first mixture material is performed for 30 minutes to 1 hour.

8. The method of claim 1, wherein the steam-heating of the first mixture material is performed in a germanium containing container.

9. The method of claim 1, wherein the ginseng is acquired and then is vacuum-packaged.

10. Processed ginseng containing a honey component which is manufactured by the method of claim 1.
